(19) United States
(12) Patent Application Publication
(10) Pub. No.: US 2026/0367894 A1
(43) Pub. Date: Nov. 19, 2026

(54) METHOD AND APPARATUS FOR LOCAL PERFORMANCE OPTIMIZATION IN COMPILER

(71) Applicant: HUAWEI TECHNOLOGIES CO., LTD., Shenzhen (CN)

(72) Inventors: Afshin Arefi, Markham (CA); Duc Minh Vu, Markham (CA); Steven Hwang, Markham (CA); Bryan Pak Kwai Chan, Markham (CA); Tomasz Sebastian Czajkowski, Toronto (CA)

(73) Assignee: HUAWEI TECHNOLOGIES CO., LTD., Shenzhen (CN)

(21) Appl. No.: 19/206,620

(22) Filed: May 13, 2025

(51) Int. Cl. G06F 8/41; G06F 12/0882; G06F 12/14

(52) U.S. Cl. CPC G06F 8/4441; G06F 12/0882; G06F 12/14

(57) ABSTRACT

There is provided a method for optimization a section of a program during compilation. The section of the program, called a kernel, is selected, and a plurality of compiler optimization options are selected. The kernel is instrumented for recording and for replaying. The recorder kernel is executed to record data which is replayed by the replayer kernel. The replayer kernel is compiled with different optimization options, and the options corresponding to the best performing version of the kernel are selected. The selected options are then applied to the kernel during compilation of the whole program, using back annotation.

### CROSS-REFERENCE TO RELATED APPLICATIONS

The present application is the first application for this disclosure.

### FIELD OF THE DISCLOSURE

The present disclosure relates to compilers. Specifically, the present disclosure provides a compiler which optimizes different code segments of a main program individually.

### BACKGROUND

Compilers translate code written in a programming language to executable instructions, for execution by a processor of a computing device. During compilation, many optimization techniques can be performed on the code to produce an executable program which has desired characteristics, such as fast performance, and small size, amongst others.

However, optimization is a costly and time-consuming task. There are many compiler optimization techniques and options that may affect the relevant characteristics of the executable file, but testing different combinations of optimization techniques, including a different ordering of optimization techniques, is impractical.

Accordingly, there is a need for a solution for optimizing executable code using compiler optimization techniques that is efficient and easy to use.

### SUMMARY

It is an object of the present disclosure to provide an improved method for compiling code into an executable file which leverages compiler optimization techniques and options to produce an executable file with the desired characteristics.

According to a first aspect, there is provided a method for compiling a program, comprising selecting a kernel from the program; determining a plurality of optimization options for a compiler; compiling, using the compiler, the kernel with each of the plurality of optimization options to create a plurality of kernel executables; executing each of the plurality of kernel executables; selecting the optimization options which correspond to the best performance of each of the plurality of kernel executables; and using back annotation to compile the program with the selected optimization options for the kernel.

According to an embodiment of the first aspect, the method further comprises instrumenting the kernel for recording to create an instrumented recorder kernel; compiling the instrumented recorder kernel to create a recorder kernel executable; and executing the recorder kernel executable to record data.

According to another embodiment of the first aspect, the method further comprises instrumenting the kernel for replaying to create an instrumented replayer kernel, wherein said compiling the kernel comprises compiling the instrumented replayer kernel with each of the plurality of optimization options.

According to yet another embodiment of the first aspect, the method further comprises creating an Intermediate Representation (IR) of the instrumented replayer kernel.

According to yet another embodiment of the first aspect, said instrumenting the kernel for recording comprises creating duplicate functions of functions called by the kernel; instrumenting the duplicate functions for recording; and modifying the kernel to call the duplicate functions.

According to yet another embodiment of the first aspect, said instrumenting the kernel for recording comprises setting permissions to create page faults upon memory access.

According to yet another embodiment of the first aspect, the method further comprises, during said executing the recorder kernel, upon detection of a page fault for a memory page, dumping the memory page to disk to create a memory page file; and setting permissions for the memory page to allow memory access.

According to yet another embodiment of the first aspect, the method further comprises, during said executing the recorder kernel, entering an external region of the kernel; returning to the kernel; and resetting permissions for memory pages which were written to during the external region to create page faults upon memory access.

According to yet another embodiment of the first aspect, the kernel is divided into a plurality of sections, each section of the plurality of sections being separated by an external region, wherein said dumping the memory page to disk comprises tagging the memory page file with a section index identifying a current section of the plurality of sections.

According to yet another embodiment of the first aspect, the method further comprises during execution of each section of the plurality of sections, pausing other threads of the recorder kernel; and during execution of external regions, resuming other threads of the recorder kernel.

According to yet another embodiment of the first aspect, the method further comprises during execution of each of the kernel executables, upon entering a section of the plurality of sections, loading all memory page files corresponding to the section.

According to a second aspect, there is provided a computing device for compiling a program comprising a processor, and memory, wherein the computing device is configured to select a kernel from the program; determine a plurality of optimization options for a compiler; compile, using the compiler, the kernel with each of the plurality of optimization options to create a plurality of kernel executables; execute each of the plurality of kernel executables; select the optimization options which correspond to the best performance of each of the plurality of kernel executables; and use back annotation to compile the program with the selected optimization options for the kernel.

According to an embodiment of the second aspect, the computing device is further configured to instrument the kernel for recording to create an instrumented recorder kernel; compile the instrumented recorder kernel to create a recorder kernel executable; and execute the recorder kernel executable to record data.

According to another embodiment of the second aspect, the computing device is further configured to instrument the kernel for replaying to create an instrumented replayer kernel, wherein said compiling the kernel comprises compiling the instrumented replayer kernel with each of the plurality of optimization options.

According to yet another embodiment of the second aspect, the computing device is further configured to create an Intermediate Representation (IR) of the instrumented replayer kernel.

According to yet another embodiment of the second aspect, said instrumenting the kernel for recording comprises creating duplicate functions of functions called by the kernel; instrumenting the duplicate functions for recording; and modifying the kernel to call the duplicate functions.

According to yet another embodiment of the second aspect, said instrumenting the kernel for recording comprises setting permissions to create page faults upon memory access.

According to yet another embodiment of the second aspect, the computing device is further configured to, during said executing the recorder kernel, upon detection of a page fault for a memory page, dump the memory page to disk to create a memory page file; and set permissions for the memory page to allow memory access.

According to yet another embodiment of the second aspect, the computing device is further configured to, during said executing the recorder kernel, enter an external region of the kernel; return to the kernel; and reset permissions for memory pages which were written to during the external region to create page faults upon memory access.

According to yet another embodiment of the second aspect, the kernel is divided into a plurality of sections, each section of the plurality of sections being separated by an external region, wherein said dumping the memory page to disk comprises tagging the memory page file with a section index identifying a current section of the plurality of sections.

According to yet another embodiment of the second aspect, the computing device is further configured to, during execution of each section of the plurality of sections, pause other threads of the recorder kernel; and during execution of external regions, resume other threads of the recorder kernel.

According to yet another embodiment of the second aspect, the computing device is further configured to, during execution of each of the kernel executables, upon entering a section of the plurality of sections, load all memory page files corresponding to the section.

According to a third aspect, there is provided a computer readable medium having stored thereon executable code for execution by a processor of a computing device, the executable code comprising instructions for selecting a kernel from the program; determining a plurality of optimization options for a compiler; compiling, using the compiler, the kernel with each of the plurality of optimization options to create a plurality of kernel executables; executing each of the plurality of kernel executables; selecting the optimization options which correspond to the best performance of each of the plurality of kernel executables; and using back annotation to compile the program with the selected optimization options for the kernel.

### BRIEF DESCRIPTION OF THE DRAWINGS

FIG. 1 is a flow diagram of a high-level optimization method according to at least some embodiments of the present disclosure.

FIG. 2 is a flow diagram of a method according to at least some embodiments of the present disclosure.

FIG. 3 is a flow diagram of a method for recording data according to at least some embodiments of the present disclosure.

FIG. 4 is a flow diagram of a method for replaying a kernel according to at least some embodiments of the present disclosure.

FIG. 5 is a block diagram of an exemplary computing device according to at least some embodiments of the present disclosure.

### DETAILED DESCRIPTION

The present disclosure provides an improved method for compiling code which leverages optimization techniques and options to produce an executable file with the desired characteristics. These characteristics may include performance, efficiency, size, memory usage, and power usage, amongst others. However, the present disclosure is not limited to any specific characteristics, or to any optimization techniques.

Rather, the present disclosure provides a method for efficiently searching the space provided by available optimization techniques in order to seek out ideal or near-ideal optimization for a given code segment. Each code segment of a program may be optimized using the methods of the present disclosure, or only some code segments of a program may be optimized.

In general terms, the present disclosure provides a method whereby a small piece of the program is built and optimized independently, and then recombined with other segments of the program to create the whole program.

The present disclosure further seeks to improve on prior art methods. For example, Ivanov et al. “Input-Gen: Guided Generation of Stateful Inputs for Testing, Tuning, and Training.” arXiv preprint arXiv:2406.08843 (2024) and Castro et al. “Cere: Llvm-based codelet extractor and replayer for piecewise benchmarking and optimization.” ACM Transactions on Architecture and Code Optimization (TACO) 12.1 (2015): 1-24 each suffer from having limited extraction scope, as they provide no solution for extracting a function from multi-threaded applications or from system-wide libraries. Moreover, these solutions have limited replay scope, as they fail to provide a solution to replay external accesses by the process (e.g., peripheral devices). Furthermore, these solutions do not allow for back annotation.

O'Callahan et al. “Engineering record and replay for deployability: Extended technical report.” arXiv preprint arXiv:1705.05937 (2017), on the other hand, has no limitations on extraction, but does not allow to test modifications to the code in a replay.

Throughout the present disclosure, the following terminology will be followed.

Kernel: A piece of code or function. In the present disclosure, the term “kernel” is used to denote a segment of code on which optimization is performed independently of other code in the program.

Back-annotation: A compiler-based technique to enable recompilation of a code segment with specific flags, optimization sequences and options. This technique allows global, module-wide flags and transforms to be applied on a single function regardless of how the required flag, optimization or option was defined. It faithfully reconstructs the optimization results obtained from a kernel optimization run in a full-application recompilation ensuring reproducibility and maintainability of results.

Tuning: An iterative process to optimize an application.

The present disclosure aims to provide a method which enables recording and replaying of applications running in a multi-process system. This is achieved in part by recording input data for a kernel. The kernel is then extracted as a standalone program. The kernel may then be executed using the recorded data, and the performance of the kernel compiled using various optimization techniques can be used to select preferable optimization techniques for the kernel. This framework allows any optimization options to apply only to a specific kernel during compilation of the whole program, thus preserving the benefits found in the optimization process.

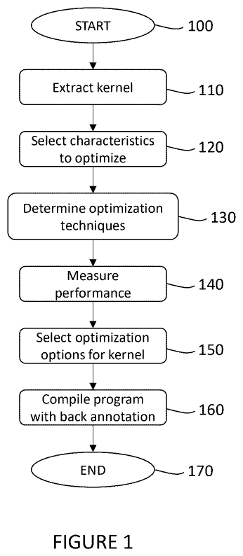

Reference is now made to FIG. 1, which illustrates a method according to the present disclosure, from a high level of generality.

The method of FIG. 1 starts at block 100 and proceeds to block 110 where a kernel is extracted. As discussed above, a kernel may be any code segment within the whole program. The kernel may be, without limitation, a function, a loop, a library, or just a few lines of code. According to at least some embodiments, the kernel may be selected by the user. Alternatively, in at least some embodiments, kernels may be extracted automatically by the compiler.

When a kernel is extracted, it is set up to run as a standalone program. This may require the setting of global variables, and the provision of suitable parameters in case the kernel is a function with parameters. According to at least some embodiments, this process may be automated.

The method then proceeds to block 120, where the characteristics to optimize in the kernel are selected. As discussed above, these characteristics may comprise, without limitation, time of execution, memory usage, size of executable, and power usage, amongst others. In some embodiments, this step may be skipped and the optimization may only seek to improve time of execution as a default. According to at least some embodiments, the characteristic or characteristics to optimize are selected by the user.

The method then proceeds to block 130, where optimization techniques to utilize are determined. In particular, whereas there may be hundreds of possible optimization techniques, or options to set on a compiler, testing each combination of possible options is impractical. However, prior knowledge may be leveraged in order to select the optimization techniques which are more likely to produce the desired benefits.

Thus, according to at least some embodiments, a user may select a subset of all optimization techniques to test. Alternatively, a subset of optimization techniques may be selected on the basis of the characteristics to optimize, as selected at block 120. Alternatively, Machine Learning (ML) techniques may be leveraged to select a subset of all available optimization techniques which are the most promising, based on the kernel and the characteristics to optimize.

The method then proceeds to block 140, where the kernel is compiled with the different optimization techniques selected at block 130 to run as a standalone program. In particular, many different versions of the kernel, each compiled using different optimization techniques, may be compiled and run as a standalone program, and the characteristics to optimize may then be measured. This step is described in greater detail below.

The method then proceeds to block 150, where the optimization techniques which produced the best result at block 140 are selected for the kernel.

The method then proceeds to block 160 where the whole program is compiled, using back annotation to ensure that the kernel (and only the kernel) is compiled using the optimization techniques selected at block 150.

The method then proceeds to block 170 and ends.

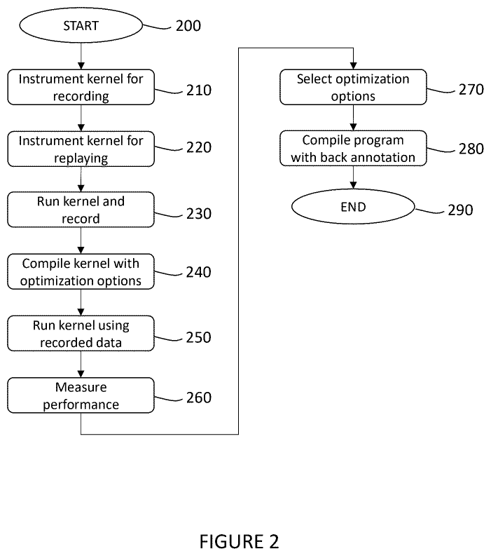

Reference is now made to FIG. 2, which illustrates some aspects of the method of FIG. 1 in greater detail.

The method of FIG. 2 starts at block 200 and proceeds to block 210 where the kernel is instrumented for recording. Specifically, code may be inserted into the kernel to record an Input/Output (I/O) profile to be used for replaying the kernel later on.

According to at least some embodiments, the functionality of the present disclosure is provided, at least in part, through a library that provides an Application Programming Interface (API). This API may include function calls that are used in instrumenting a kernel for recording. This library shall be referred to in the present disclosure as the Replayable Kernel Extraction (RKE) library. In the following code examples, any function that is part of the RKE library will have a name with the “rke” prefix.

Assuming that the main program uses a shared library and the kernel selected for optimization is a function from this library called example_kernel, shown in Table 1.

TABLE 1
Example Kernel

```
int example_kernel(std::string s, std::vector<int> d ) {
  ...
  ...
  int x = External_Function_A(...);
  ...
  ...
  External_Function_B(...);
  ...
  ...
  return R;
}
```

As seen from Table 1 above, the example_kernel function has two parameters, a string s, and an integer vector d. Most of the code in the function is represented by ellipsis, as the specific content of the code is not relevant. Notably however, the function includes calls to external functions, namely External_Function_A and External_Function_B. These external functions may be part of a different library, and are not meant to be included in the optimization process.

After the example_kernel function has been instrumented for recording, it may be as illustrated in Table 2.

TABLE 2
Example Kernel Instrumented for Recording

```
int example_kernel(std::string s, std::vector<int> d ) {
  rke_recorder_enterKernel( );
  rke_recorder_saveVariable(&s, sizeof(std::string));
  rke_recorder_saveVariable(&d, sizeof(std::vector));
  ...
  ...
  rke_recorder_enterExternalRegion( );
  int x = External_Function_A(...);
  rke_recorder_exitExternalRegion(&x, sizeof(int));
  ...
  ...
  rke_recorder_enterExternalRegion( );
  External_Function_B(...);
  rke_recorder_exitExternalRegion(null, 0);
  ...
  ...
  rke_recorder_exitKernel( );
  return R;
}
```

As seen from the above Table 2, a call to rke_recorder_enterKernel( ) is made at the beginning of the kernel, to begin recording. As will be appreciated, the name of the function rke_recorder_enterKernel( ) is merely provided as an example. More generally, the kernel is modified to insert a call to start recording at the beginning of the kernel.

Because this example kernel is a function with two parameters, namely the string s and the integer vector d, calls to rke_recorder_SaveVariable( ) are also inserted for each parameter. Again, the name of the function rke_recorder_SaveVariable( ) is merely provided as an example. More generally, the kernel is modified to save input parameters after the recording is started. In the above example, the parameters to the rke_recorder_SaveVariable( ) function are an address for the variable, and a size of the variable.

The kernel is further modified around calls to external functions. Identifying external functions is known in the art and any suitable method may be utilized. As seen above in Table 2, just before the call to External_Function_A( ), a call to rke_recorder_enterExternalRegion( ) is made, to indicate to the recorder to pause recording during the call to the external function. Again, the name of the function rke_recorder_enterExternalRegion( ) is merely provided as an example. More generally, the kernel is modified to pause the recording before a call to an external function.

After the call to External_Function_A( ), a call to rke_recorder_exitExternalRegion( ) is made, to indicate to the recorder to resume recording after the call to the external function. Again, the name of the function rke_recorder_exitExternalRegion( ) is merely provided as an example. More generally, the kernel is modified to resume the recording after a call to an external function.

In this case, the external function returns an integer value which is stored in local variable x. This information is saved by providing as parameters to rke_recorder_exitExternalRegion, the address of local variable x and the size of local variable x.

In the present example, there is also a call to External_Function_B( ), which is treated similarly to the call to External_Function_A( ), with the distinction that External_Function_B( ) does not return a value, and therefore the parameters to rke_recorder_exitExternalRegion are a NULL pointer and 0. In general, if an external function returns a value that is stored in a variable, the address and the size of the variable are provided as parameters to the function called when exiting an external region, in order to save the value of the variable.

The kernel is then modified to include a call to rke_recorder_exitKernel( ), at the end of the kernel, to indicate to the recorder to stop recording. Again, the name of the rke_recorder_exitKernel( ), function is merely provided as an example. More generally, the kernel is modified to stop recording at the end of the kernel. As the kernel in the present example is a function, the rke_recorder_exitKernel( ) call is inserted just before the “return” statement. However, in other cases, this function may simply be called at the end of the kernel.

According to at least some embodiments, block 210 may further create duplicate functions for functions called by the kernel, where the duplicate function is instrumented for recording while the original function is not. The instrumented function may then be called from the kernel, whereas the original function is called from other sections of the main program.

Thus, after block 210, the kernel is modified to record an I/O profile during execution. This version of the kernel shall be referred to as the recorder kernel throughout this disclosure.

The method then proceeds to block 220, where the kernel is instrumented for replay. In at least some embodiments, this is also achieved by inserting calls to the RKE library API. Specifically, based on the above example, the kernel instrumented for replay may be as shown in Table 3.

TABLE 3
Example Kernel Instrumented for Replaying

```
int example_kernel(std::string s, std::vector<int> d ) {
  rke_replayer_enterKernel( );
  rke_replayer_loadVariable(&s, sizeof(std::string));
  rke_replayer_loadVariable(&d, sizeof(std::vector));
  ...
  ...
  int x;
  rke_replayer_replaceExternalRegion(&x, sizeof(int));
  ...
  ...
  rke_replayer_replaceExternalRegion(null, 0);
  ...
  ...
  rke_replayer_exitKernel( );
  return R;
}
```

As seen in Table 3, a call to rke_replayer_enterKernel( ) is made at the beginning of the kernel, to begin replaying. As will be appreciated, the name of the function rke_replayer_enterKernel( ) is merely provided as an example. More generally, the kernel is modified to insert a call to start replaying at the beginning of the kernel.

Because this example kernel is a function with two parameters, namely the string s and the integer vector d, calls to rke_recorder_LoadVariable( ) are also inserted for each parameter. Again, the name of the function rke_recorder_LoadVariable( ) is merely provided as an example. More generally, the kernel is modified to load input parameters after the replaying is started. In the above example, the parameters to the rke_recorder_LoadVariable( ) function are an address for the variable, and a size of the variable.

The kernel is further modified around calls to external functions. As seen above in Table 3, the call to External_Function_A( ) is replaced by a call to rke_replayer_replaceExternalRegion( ). Again, the name of the function rke_replayer_replaceExternalRegion( ) is merely provided as an example. More generally, the kernel is modified to not make calls to external functions during replay.

In this case, the external function returns an integer value which is stored in local variable x. This information is preserved by providing as parameters to rke_replayer_replaceExternalRegion( ), the address of local variable x and the size of local variable x. During replay execution, the value of x which was saved by a call to rke_recorder_exitExternalRegion(&x, sizeof(int)), will be assigned to variable x.

In the present example, there is also a call to External_Function_B( ), which is treated similarly to the call to External_Function_A( ), with the distinction that External_Function_B( ) does not return a value, and therefore the parameters to rke_replayer_replaceExternalRegion( ) are a NULL pointer and 0. In general, if an external function returns a value that is stored in a variable, the address and the size of the variable are provided as parameters to the function called for replacing an external region, in order to load the value of the variable.

The kernel is then modified to include a call to rke_replayer_exitKernel( ), at the end of the kernel, to indicate to the replayer to stop replaying. Again, the name of the rke_replayer_exitKernel( ) function is merely provided as an example. More generally, the kernel is modified to stop replaying at the end of the kernel. As the kernel in the present example is a function, the rke_replayer_exitKernel( ) call is inserted just before the “return” statement. However, in other cases, this function may simply be called at the end of the kernel.

Thus, after block 220, the kernel is modified to replay the I/O profile that was recorded during execution of the recorder kernel. This version of the kernel shall be referred to as the replayer kernel throughout this disclosure.

According to some embodiments, the replayer kernel is converted to Intermediate Representation (IR) and only the IR version of the replayer kernel is stored. This allows to more efficiently create multiple executable versions of the kernel with different optimization options.

The method then proceeds to block 230, where the recorder kernel is run and an I/O profile for the kernel is recorded. According to at least some embodiments of the present disclosure, the I/O profile is recorded in a directory, with sub-directories being used to store various memory pages and variables that are accessed during the execution of the recorder kernel. According to at least some embodiments, memory pages may be processed to merge neighboring pages together, making the replay process more efficient and preventing going over mapped region count limits.

The method then proceeds to block 240, where the replayer kernel is compiled using different optimization options.

The method then proceeds to block 250, where the different kernels compiled with different optimization options are run.

The method then proceeds to block 260, where the performance of each different kernel compiled at block 250 is measured.

The method then proceeds to block 270, where preferred optimization options are selected based on the measurement of block 260.

The method then proceeds to block 280, where the main program is compiled using back annotation to ensure that the optimization options selected at block 270 are applied only to the kernel.

The method then ends at block 290.

Based on the foregoing, at least some embodiments of the present disclosure comprise an RKE library which provide APIs that allow marking the start and end of kernel regions, the start and end of external regions, saving and loading of local or global variables, and performance measurement of the kernel. Embodiments of the present disclosure may also comprise a tracer program for allowing communication with the target application for the purpose of recording.

In embodiments with a tracer program, the kernel recorder can be run normally without any changes to its behavior. In order to start the recording and activate the API calls, the tracer program may be invoked with the process identifier of the kernel recorder.

In at least some embodiments, the tracer program may trace the kernel recorder using the ptrace library, which is a library available on some operating systems such as Unix™, Linux™, and MacOS™.

The kernel recorder will notice that it is being traced by the tracer when the API call at the beginning of the kernel region is called. The kernel recorder will then send a signal to the tracer program which allows the tracer program to know the tracee (i.e., the kernel recorder) is entering the kernel region.

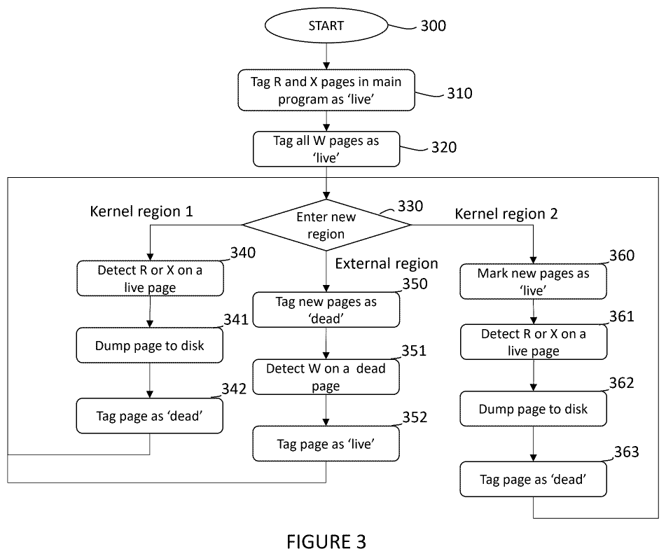

Reference is now made to FIG. 3, which illustrates a process for recording data during the execution of the recorder kernel, according to at least some embodiments of the present disclosure.

The method of FIG. 3 starts at block 300 and proceeds to block 310 where memory pages of the main program with read (R) or execute (X) permissions are tagged as ‘live’, and their permissions will be set to forbid access.

When a page is tagged as ‘live’, this indicates that any read or execute access by the kernel should be dumped to disk. When a page is tagged as ‘dead’, this indicates that any read or execute access by the kernel should not be dumped to disk.

The method then proceeds to block 320 where all memory pages with write (W) permissions are tagged as ‘live’.

The method then proceeds to block 330 where a new section of code is entered. In particular, the new section of code may be the kernel, or an external region from the kernel. At this stage, the tracer may pause all other threads in the process, so that their access to the memory will not affect the recording.

When the kernel is entered into for the first time, the method proceeds to block 340, where a read or an execute operation on a page may be detected.

As the permission for this page has been set to deny access, this creates a page fault, which allows the tracer to determine that there has been a memory access to this page. The method then proceeds to block 341, where the memory page is dumped to disk, or otherwise stored. The page is then marked as ‘dead’ at block 342 and the permissions are restored to their original values.

Blocks 340 to 342 may be repeated until the program enters an external section.

Some variables such as function arguments or global variables may be saved separately since they might be kept in registers or accessed through a reference, and these variables are saved at the start of the kernel region using API calls to the RKE library as described above.

During the execution of the kernel, whenever a memory page is accessed, the tracer will receive a page-fault, the page is dumped as data to be used for the replay and the memory page permissions will be restored to the original values. Hence, each memory page used by the kernel region may only be dumped once and as the recording continues and more pages are accessed, fewer and fewer page-faults will occur.

When an external region of the program is entered, the method proceeds to block 350, where newly allocated regions (i.e., allocations from the external call) are tagged as ‘dead’.

The method then proceeds to block 351, where a write operation is detected on a dead page. The method then proceeds to block 352, where the page is tagged as ‘live’.

As discussed above, external regions are marked by APIs that lets the tracer know that external region pages are not to be recorded. When such a region is reached, the recorder kernel may only monitor the effects of these regions on the memory pages that have already been accessed by the kernel and dumped to disk. If this external region writes into such pages, and the kernel region accesses these pages again afterwards, these write operations should be reflected in the dumped data, after exiting the external region.

This is achieved by tagging pages dumped during the kernel region as dead, and removing their write permission so that writing into such pages will cause a page-fault. As access to any other page is not relevant to the present purposes, their original permissions may be restored for the duration of the external region.

During the external region, all threads may be resumed since it is not important which specific thread is accessing memory pages during external regions, and this may also prevent potential dead locks.

At the end of the external region, the method returns to block 330, where it enters a second kernel region. The method then proceeds to block 360, where any new memory page is tagged as ‘live’. In at least some embodiments, all other threads are paused again.

The method then proceeds to block 361, where a read or execution access is detected on a live page. The method then proceeds to block 362 where the page is dumped to disk. The method then proceeds to block 363 where the page is tagged as ‘dead’.

As the relevant version of the page during this kernel region (i.e., after an external region) may be different than the relevant version of the page during the previous kernel region (i.e., before the external region), the page is dumped in a different file than the previous version of the same page (if any). More generally, each kernel region is defined by boundaries which may be a start of the kernel, an external region, and the end of the kernel. Each data dump to disk for a given memory page may be different for each kernel region. According to at least some embodiments, each kernel region is indexed and the index may be used to store and access the correct version of the given memory page.

The process of entering and exiting external regions may happen many times until the kernel is finished executing. When the kernel ends, all memory page permissions may be returned to their original states, and the tracer and tracee programs may end.

For single threaded applications, the tracer process may be implemented using signal handlers in the tracee process. In systems that do not support multiple processes and do not have signal handing, all memory accesses may be marked using instrumentation. This has a much higher overhead but allows such systems to implement the present disclosure.

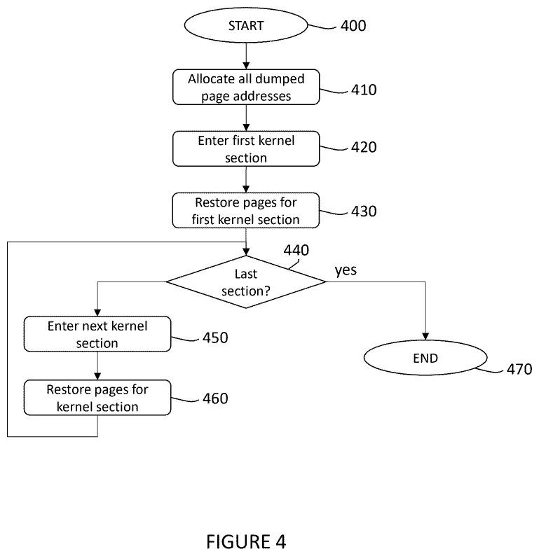

Reference is now made to FIG. 4, in which a method for replaying the kernel with the recorded data is illustrated.

The method of FIG. 4 starts at block 400 and proceeds to block 410 where all pages that were dumped during the recording phase are allocated to memory. Specifically, each page dumped during the recording phase corresponds to a section of memory, and to a kernel section. Each such section of memory may then be mapped to a section of memory in the kernel replayer process.

The method then proceeds to block 420 where the first kernel section is entered. As discussed above, the first kernel section starts at the beginning of the kernel, and goes up to the first external section. At this stage, global variables are restored and function arguments that were saved are loaded using. As discussed above, this may be achieved using the RKE API.

The method then proceeds to block 430 where the dumped pages for the first kernel section are restored. Specifically, any page that was dumped during execution of the first kernel section of the recorder kernel is loaded into the appropriate section of memory allocated at block 410. The first kernel section may then be executed with the assurance that all memory accesses needed during the replay will have the right value in memory and the kernel code can run without any performance penalty.

In at least some embodiments, the RKE API may also measure the time taken to execute the kernel code.

The method then proceeds to block 440 to check if the current kernel section is the last kernel section. If yes, the method ends at block 470. If no, the method proceeds to block 450 to enter the next kernel section.

The method then proceeds to block 460 to restore the dumped pages for the current kernel section. Again, any page that was dumped during the corresponding kernel section of the recorder kernel is loaded into the appropriate section of memory allocated at block 410. The current kernel section may then be executed, and the method then returns to block 440 to check if the current kernel section is the last kernel section. Blocks 440, 450, and 460 may be repeated until the last section of the kernel is executed, at which point the method ends at block 470.

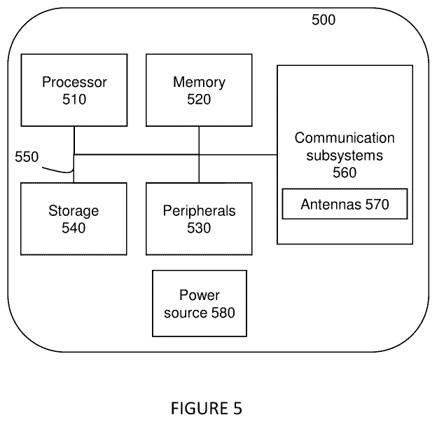

The above functionality may be implemented on any one or combination of computing devices. FIG. 5 is a block diagram of a computing device 500 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The computing device 500 may comprise a processor 510, memory 520, a mass storage device 540, and peripherals 530. Peripherals 530 may comprise, amongst others one or more input/output devices, such as a speaker, microphone, mouse, touchscreen, keypad, keyboard, printer, display, network interfaces, and the like. Communications between processor 510, memory 520, mass storage device 540, and peripherals 530 may occur through one or more buses 550.

The bus 550 may be one or more of any type of several bus architectures including a memory bus or memory controller, a peripheral bus, video bus, or the like. The processor 510 may comprise any type of electronic data processor. The memory 520 may comprise any type of system memory such as static random-access memory (SRAM), dynamic random-access memory (DRAM), synchronous DRAM (SDRAM), read-only memory (ROM), a combination thereof, or the like. In an embodiment, the memory 520 may include ROM for use at boot-up, and DRAM for program and data storage for use while executing programs.

The mass storage device 540 may comprise any type of storage device configured to store data, programs (e.g. instructions or code), and other information and to make the data, programs, and other information accessible via the bus. The mass storage device 540 may comprise, for example, one or more of a solid-state drive, hard disk drive, a magnetic disk drive, an optical disk drive, or the like. The memory 520 or mass storage 540 may store instructions, which when executed by a processor or processing unit, cause or configure the computing device 500 to perform any of the methods described herein.

Computing device 500 may further comprise a communications subsystem 560 for communicating with other computing devices or for connecting computing device 500 to a computer network. Communications subsystem 560 may comprise one or more network interfaces (not shown), which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas 570 and one or more receivers/receive antennas 570. In an embodiment, the processing unit is coupled to a local-area network or a wide-area network, for data processing and communications with remote devices, such as other processing units, the Internet, remote storage facilities, or the like.

Computing device may further comprise a power source 580.

The present disclosure may be implemented on a computing device such as exemplary computing device 500. Computing device 500 may be a network element of a telecommunications network, such that the network element may be connected to other network elements of the telecommunication network, where all network elements form the telecommunication network. The network element may also receive communications from client devices connected to the telecommunication network and provide services to such client devices.

Through the descriptions of the preceding embodiments, the teachings of the present disclosure may be implemented by using hardware only or by using a combination of software and hardware. Software or other computer executable instructions for implementing one or more embodiments, or one or more portions thereof, may be stored on any suitable computer readable storage medium. The computer readable storage medium may be a tangible or in transitory/non-transitory medium such as optical (e.g., CD, DVD, Blu-Ray, etc.), magnetic, hard disk, volatile or non-volatile, solid state, or any other type of storage medium known in the art.

Additional features and advantages of the present disclosure will be appreciated by those skilled in the art.

The structure, features, accessories, and alternatives of specific embodiments described herein and shown in the Figures are intended to apply generally to all of the teachings of the present disclosure, including to all of the embodiments described and illustrated herein, insofar as they are compatible. In other words, the structure, features, accessories, and alternatives of a specific embodiment are not intended to be limited to only that specific embodiment unless so indicated.

Moreover, the previous detailed description is provided to enable any person skilled in the art to make or use one or more embodiments according to the present disclosure. Various modifications to those embodiments will be readily apparent to those skilled in the art, and the generic principles defined herein may be applied to other embodiments without departing from the spirit or scope of the teachings provided herein. Thus, the present methods, systems, and or devices are not intended to be limited to the embodiments disclosed herein. The scope of the claims should not be limited by these embodiments, but should be given the broadest interpretation consistent with the description as a whole. Reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims.

Furthermore, nothing herein is intended as an admission of prior art or of common general knowledge. Furthermore, citation or identification of any document in this application is not an admission that such document is available as prior art, or that any reference forms a part of the common general knowledge in the art. Moreover, nothing disclosed herein is intended to be dedicated to the public regardless of whether such disclosure is explicitly recited in the claims.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A method for compiling a program, comprising:
selecting a kernel from the program;
determining a plurality of optimization options for a compiler;
compiling, using the compiler, the kernel with each of the plurality of optimization options to create a plurality of kernel executables;
executing each of the plurality of kernel executables;
measuring a performance of each of the plurality of kernel executables;
selecting the optimization options which correspond to the best performance of each of the plurality of kernel executables; and
using back annotation to compile the program with the selected optimization options for the kernel.

2. The method of claim 1, further comprising:
instrumenting the kernel for recording to create an instrumented recorder kernel;
compiling the instrumented recorder kernel to create a recorder kernel executable; and
executing the recorder kernel executable to record data.

3. The method of claim 2, further comprising, instrumenting the kernel for replaying to create an instrumented replayer kernel, wherein said compiling the kernel comprises compiling the instrumented replayer kernel with each of the plurality of optimization options.

4. The method of claim 3, further comprising, creating an Intermediate Representation (IR) of the instrumented replayer kernel.

5. The method of claim 2, wherein said instrumenting the kernel for recording comprises:
creating duplicate functions of functions called by the kernel;
instrumenting the duplicate functions for recording; and
modifying the kernel to call the duplicate functions.

6. The method of claim 3, wherein said instrumenting the kernel for recording comprises setting permissions to create page faults upon memory access.

7. The method of claim 6, further comprising, during said executing the recorder kernel:
upon detection of a page fault for a memory page, dumping the memory page to disk to create a memory page file; and
setting permissions for the memory page to allow memory access.

8. The method of claim 7, further comprising, during said executing the recorder kernel:
entering an external region of the kernel;
returning to the kernel; and
resetting permissions for memory pages which were written to during the external region to create page faults upon memory access.

9. The method of claim 7, wherein the kernel is divided into a plurality of sections, each section of the plurality of sections being separated by an external region, wherein said dumping the memory page to disk comprises tagging the memory page file with a section index identifying a current section of the plurality of sections.

10. The method of claim 9, further comprising:
during execution of each section of the plurality of sections, pausing other threads of the recorder kernel; and
during execution of external regions, resuming other threads of the recorder kernel.

11. The method of claim 9, further comprising, during execution of each of the kernel executables:
upon entering a section of the plurality of sections, loading all memory page files corresponding to the section.

12. A computing device for compiling a program comprising:
a processor; and
memory;
wherein the computing device is configured to:
select a kernel from the program;
determine a plurality of optimization options for a compiler;
compile, using the compiler, the kernel with each of the plurality of optimization options to create a plurality of kernel executables;
execute each of the plurality of kernel executables;
measure a performance of each of the plurality of kernel executables;
select the optimization options which correspond to the best performance of each of the plurality of kernel executables; and
use back annotation to compile the program with the selected optimization options for the kernel.

13. The computing device of claim 12, further configured to:
instrument the kernel for recording to create an instrumented recorder kernel;
compile the instrumented recorder kernel to create a recorder kernel executable; and
execute the recorder kernel executable to record data.

14. The computing device of claim 13, further configured to instrument the kernel for replaying to create an instrumented replayer kernel, wherein said compiling the kernel comprises compiling the instrumented replayer kernel with each of the plurality of optimization options.

15. The computing device of claim 14, wherein said instrumenting the kernel for recording comprises setting permissions to create page faults upon memory access.

16. The computing device of claim 15, further configured to, during said executing the recorder kernel:
upon detection of a page fault for a memory page, dumping the memory page to disk to create a memory page file; and
setting permissions for the memory page to allow memory access.

17. The computing device of claim 16, further configured to, during said executing the recorder kernel:
enter an external region of the kernel;
return to the kernel;
reset permissions for memory pages which were written to during the external region to create page faults upon memory access.

18. The computing device of claim 16, wherein the kernel is divided into a plurality of sections, each section of the plurality of sections being separated by an external region, wherein said dumping the memory page to disk comprises tagging the memory page file with a section index identifying a current section of the plurality of sections.

19. The computing device of claim 18, further configured to, during execution of each of the kernel executables:
upon entering a section of the plurality of sections, load all memory page files corresponding to the section.

20. A computer readable medium for compiling a program, having stored thereon executable code for execution by a processor of a computing device, the executable code comprising instructions for:
selecting a kernel from the program;
determining a plurality of optimization options for a compiler;
compiling, using the compiler, the kernel with each of the plurality of optimization options to create a plurality of kernel executables;
executing each of the plurality of kernel executables;
measuring a performance of each of the plurality of kernel executables;
selecting the optimization options which correspond to the best performance of each of the plurality of kernel executables; and
using back annotation to compile the program with the selected optimization options for the kernel.
